(19) United States
(12) Patent Application Publication
(10) Pub. No.: US 2019/0066079 A1
(43) Pub. Date: Feb. 28, 2019

(54) METHODS AND SYSTEMS USING A COMPUTING PLATFORM FOR ROUTING VIRTUAL RECEIPTS TO CUSTOMERS WITH A SCAN-ABLE CODE GENERATED BY THE MERCHANT

(71) Applicant: salesforce.com, inc., San Francisco, CA (US)

(72) Inventors: FAN LIU, BOCA RATON, FL (US); RAJEEV SHIMOGA KUMAR, DEERFIELD BEACH, FL (US)

(73) Assignee: salesforce.com, inc., San Francisco, CA (US)

(21) Appl. No.: 15/692,399

(22) Filed: Aug. 31, 2017

(51) Int. Cl. G06Q 20/20; G06Q 20/32; G06K 19/06

(52) U.S. Cl. CPC G06Q 20/208; G06Q 20/209; G06Q 2220/00; G06K 19/06037; G06Q 20/3276

(57) ABSTRACT

A method and system for routing receipts to customers by merchants using a computing platform which includes generating a scan-able code by a merchant point of sale (POS) device for capturing by a mobile device of a customer to receive a virtual receipt of the transaction, generating, by the merchant POS, identifying data for the customer by combining data from the scan-able code with identifying data generated by the merchant POS relating to the transaction wherein the identifying data includes identifiers of one or more of: time stamp data of the transaction, data about items or services purchased in the transaction; and random data generated by the merchant POS during the time of the transaction and sending, by the merchant POS using the computing platform, the identifying data to an app cloud storage wherein the app cloud storage is configured as a block chain ledger accessible by the customer.

### TECHNICAL FIELD

Embodiments of the subject matter described herein relate to distributing information of transactions between merchants and customers. More particularly, embodiments of the subject matter relate to methods and systems for routing virtual receipts to customers using a computing platform by a merchant and customer where the merchant generates a scan-able code for capture by the customer when the merchant performs a transaction with the customer in order to send and for the customer to receive a virtual receipt by using identifying data of the scan-able code and related generated transactional data.

### BACKGROUND

When performing a transaction with a merchant for goods or services it is common place to receive a paper receipt which is physically handed to the customer by the merchant for retention while the merchant retains an electronic copy. Attempts to render the receipt process paperless, that is to avoid giving paper receipts to customers are usually in the form of a customer entering or giving the merchant an email address at time of the transaction with the merchant so the merchant can send a virtual receipt to email address given by the customer. However, there are significant drawbacks with this approach in that customers are hesitant to give out email or other personal information particular to the customer for sending information because of privacy concerns. In addition, it is often the case that a customer is orally asked for her email address or telephone number which further raises a customer's apprehension because the customer must respond by orally disclosing such information in the vicinities of other customers. Also, there is a general belief by customers that merchants will use such information to send marketing material or even sell such information to third parties and their email accounts will be undulated with spam marketing mails. Further, asking a customer for an email address and inputting the email address at point of sale (POS) into a POS device at time of checkout is time consuming, adds another step to a process already deemed time consuming by the customer and because customers want to check-out quickly is often fraught with mistakes in the spelling of the email address itself while entered by the merchant or customer. Additionally, these prior paperless processes have not been given much support on the part of the merchants because the added steps in the check-out process to send paperless receipts are simply not a priority to merchants; and moreover, viewed as a burdensome obstacle to the merchant to completing transactions quickly and maximizing the number of customers that can be checked-out quickly at the POS so profits accordingly can be maximized.

Accordingly, it is desirable to create a process for managing virtual receipts for receipt by a customer from a merchant at the time of a transaction that does not interfere significantly with the latency time of an entire transaction on a per customer basis, that preserves the privacy concerns of the customer and that can easily be adherable to by both the merchant and the customer using common daily used technologies.

Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an exemplary diagram illustrating scan-able codes generated by the merchant for a computing platform using a receipt management app for distributing virtual receipts to customers in accordance with an embodiment;

FIG. 2 is an exemplary diagram illustrating scan-able codes generated by the customers for a computing platform using a receipt management app for distributing virtual receipts to customers in accordance with an embodiment;

FIG. 3 is an exemplary diagram illustrating a computing platform using a receipt management app of a receipt app client and server system for capturing scan-able codes by customers for a receipt app system for distributing virtual receipts to customers in accordance with an embodiment in accordance with an embodiment;

FIG. 4 is an exemplary diagram illustrating a computing platform using a receipt management app of a receipt app client and server system for capturing scan-able codes by merchants for a receipt app system for distributing virtual receipts to customers in accordance with an embodiment in accordance with an embodiment;

FIG. 5 is an exemplary flowchart illustrating a computing platform using a receipt management snap-in-agent for capturing scan-able codes by customers for a receipt app system for distributing virtual receipts to customers in accordance with an embodiment in accordance with an embodiment;

FIG. 6 is an exemplary flowchart illustrating a computing platform using a receipt management snap-in-agent for capturing scan-able codes by customers for a receipt app system for distributing virtual receipts to customers in accordance with an embodiment in accordance with an embodiment;

FIG. 7 is an exemplary flowchart illustrating a computing platform using a receipt management snap-in-agent for capturing scan-able codes by customers for a receipt app system for distributing virtual receipts to customers in accordance with an embodiment in accordance with an embodiment;

FIG. 8 is an exemplary flowchart illustrating a computing platform using a blockchain ledger for storing data of a receipt management app of a receipt app client and server system for capturing scan-able codes by merchants for a receipt app system for distributing virtual receipts to customers in accordance with an embodiment in accordance with an embodiment;

FIG. 9 is an exemplary flowchart illustrating a computing platform using a blockchain ledger for storing data of a receipt management app of a receipt app client and server system for capturing scan-able codes by merchants for a receipt app system for distributing virtual receipts to customers in accordance with an embodiment in accordance with an embodiment; and

FIG. 10 is a schematic block diagram of a computing platform using a receipt management app in a multi-tenant computing environment for use in conjunction a receipt app client and server system for capturing scan-able codes by merchants for a receipt app system for distributing virtual receipts to customers in accordance with an embodiment in accordance with an embodiment.

### DETAILED DESCRIPTION

Many companies have opted to develop processes for virtualizing the entire customer merchant transactional payment process from when a customer begins a transaction for a selected item or service, to when the customer pays for the item or service and the delivery of the receipt information of the item paid for or service rendered. A significant drawback occurs when the entire pipeline of the transaction between the merchant and customer is virtualized in that then the entire pipeline includes the banking information of the customer in the pipeline which is highly sensitive information and which is vulnerable to theft by unauthorized third party intrusions into the pipeline. That is, the highly sensitive data including customers bank accounts and credits card may and often are a target of theft as it is generally accepted that the safeguards to prevent such thefts can be compromised. For example, the databases of a plethora of large retailers have been and will continue to targeted and have been subject to hacking resulting in customer's credit card information being compromised.

Hence, there is a reluctance to continue to virtualize the entire pipeline because any additional processes added to pipeline by the merchant may in turn expose the merchants to further liabilities if a breach occurs; and these breaches result in not only monetary losses to the merchant but also negative publicity which also erodes profit margins for the merchants. In order to combat these issues, what has emerged are rudimentary process to capture the receipt information and not interfere with the legacy transactional processes that storing the banking information already in place. For example, one rudimentary process often used is to have a customer using a smart phone at check-out to manually capture an image of the paper receipt printed out by the merchant. This process has drawbacks as storage, retrieval and filing of the receipt often prove cumbersome as the captured receipt image of the paper receipt is intermingled with the customer's other images and likely lost with customer collections. In addition, environmental conditions such as luminesce and hand stability can lead to blurry images of the receipts captured that may not be readable or sufficiently clear to identify the retrieved item information on the receipts or other transactional information therein if needed. Further, the receipt image captured is often locally stored on the customer's devices and without the device or if the device is lost the customer usually cannot retrieve the receipt image. Finally, addition solutions applied like data extraction of the receipt data from an image capture of the receipt is likely not always accurate or feasible. Moreover, further analytical solutions derived from data amalgamation of the receipt data are also likely not feasible given the data extraction issues resulting from the image capture.

Hence, it is desirable for a receipt managing app to not be directly integrated into the transactional pipeline to prevent any exposure of the banking information of a customer and merchant transaction and not to be integrated with sensitive customer credit card and banking information generally performed on a more secure closed system to systems associated with the receipt routing and storage.

It is desirable for distributing virtual receipt information which does not require such significant safeguards from hacking with legacy transactional systems that store and process banking information.

It is desirable for a virtual receipt routing system to be integrated in a seamless manner in current transactional processes used by both customers and merchants, and which are accustomed to both the customers and merchants.

It is desirable for a receipt managing app to retain the virtual receipt information in a permanent ledger accessible by both the customer and the merchant at any time and the ledger being unchangeable so that even if hacked the ledger information of the transactions performed cannot be modified so fraudulent returns of items using false receipt information do not or are at least prevented from occurring.

It is desirable to seamlessly integrate a receipt routing app into the customer and merchant transaction occurrence in a manner that causes little if any interference in the customary payment during the transaction, that allows for notification of the available option of a receipt that allows for minimal actions on the part of the customer and the merchant and uses off the shelf technologies and smart phones commonly used by customers.

It is desirable to provide analytic tools to both merchants and customers about transactional data captured in the virtual receipts by the receipt managing apps as well as daily or as desired alerts about related transactional data, advertisements and events.

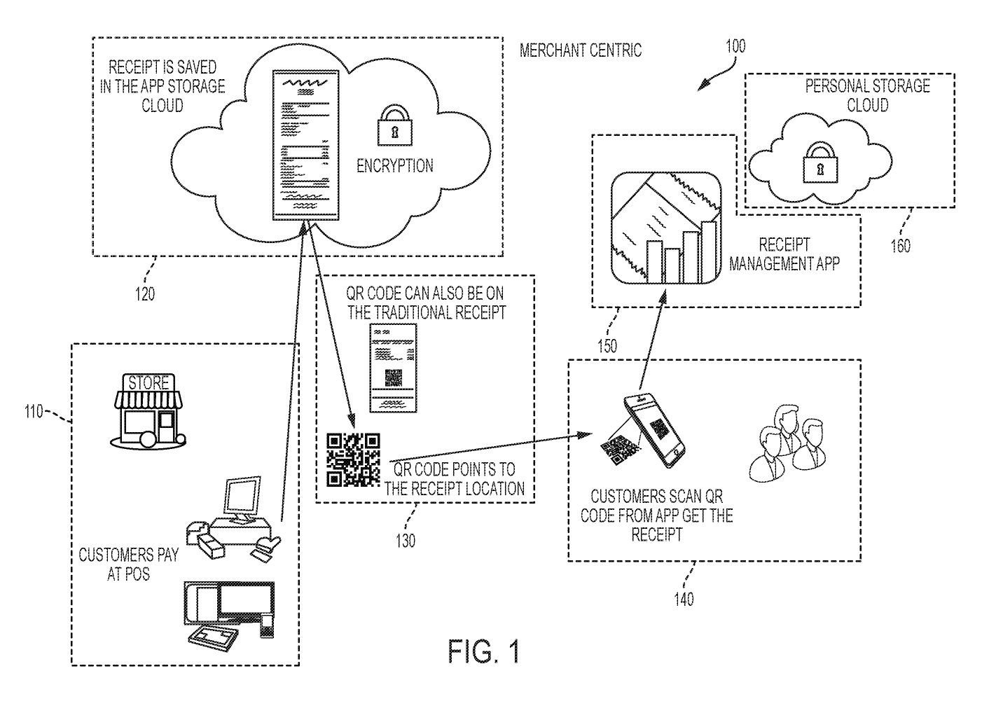

With a reference to FIG. 1, FIG. 1 is an exemplary diagram illustrating scan-able codes generated by the merchant for a computing platform using a receipt management app for distributing virtual receipts to customers in accordance with an embodiment. FIG. 1. Includes a POS system 110 connected to the app storage cloud 120, a scan-able code 130 for scanning and image capture by a mobile device 140 and a receipt management app 150 is hosted on the mobile device 140 of the customer. The scan-able code 130 may include a variety of scan-able type indicia. For example, a scan-able code 130 may be a matrix code, a 2-dimensional code, a quick response (QR) code, or a universal product code (UPC) code. It an exemplary embodiment, it is contemplated that QR-codes are used as the scan-able code 130 but the disclosure is not limited to QR-codes but to any indicia that allows for unique identifying properties that are machine-readable and can be deciphered by processors and further may be used for tracking customers with products and services. Further, it is contemplated that the scan-able code 130 have properties like the QR-codes of enabling actions upon scanning to be performed by mobile devices, smart phones or the like. For example, the scan-able code 130 like a QR-code may allow routing to a personal storage cloud 160 or alternatively to other websites or third party cloud repositories. In some instances, the scan-able code 130 includes functionality that links to website etc. The scan-able code 130 like the QR-code may contain a website address URL pointing to a ledger of the virtual receipt information. The QR-code allows for easy access to a website without a customer typing any web addresses into his/her mobile device 140 or smartphone.

The receipt management app 150 communicates locally with a receipt data storage in memory in the mobile device 140 or is connected to the cloud and communicates with an app storage cloud 120. The receipt management app 150 is configured to manage the receipts, that is the receipt may be categorized per retailer names, types of products, dates when bought, and this information including any metadata derived during the transaction by the mobile device 140 will be stored in the app storage cloud 120. The app storage cloud 120 may be used as a repository of records of the virtual receipts and the virtual receipt record information can be uploaded or sent upon completion of a transaction at the POS system 110 by the merchant with the merchant adding unique identifier information to enable the customer to identify and retrieve the record. The unique identifier information that the merchant may include can be, for example, the time information generated during times of the transaction with the customer, that is time information derived at any time, times or moments during the transaction including the length of the time of the transaction, time for scanning each of the items at the POS system 110, time for processing the payment; in other words, a variety of different types of time information may be generated to create or be included in the unique identifier. In addition, other session information may be included such as items or services rendered, date information, and potentially other types of meta data capture by the POS system 110 about the customer performing the transaction in attempts to distinguish and make unique the identifier information of the receipt record stored in the app storage cloud 120 for further retrieval by the customer. Additionally, various encryption schemes may be used to secure the receipt information in the app storage cloud 120. Once a payment of a transaction is performed by the customer at the POS system 110, the customer may be given the option of to receive a virtual receipt rather than a paper receipt. That is, the customer can make the determination in real-time whether the customer desired the paper-less option of the virtual receipt or desires a paper receipt or in other instances, may desire both the paperless virtual receipt and the paper receipt. Hence, the customer upon payment for items or services has several options presented as to the type of receipt routing or delivery desired. In addition, the customer the customer may retain a local copy of the receipt information on the mobile device 140 retrieved from the app storage cloud 120 or from the personal storage cloud 160. The personal storage cloud 160 may be configured as database part of a multi-tenant database structure connected to the app storage cloud 120. Alternatively, the personal storage cloud 160 may be coupled to other third party databases and may be enhanced with data about the transaction information discerned from the virtual receipt. Additionally, analytics engines may be coupled to the personal storage cloud 160 for providing data analysis of the customer's virtual receipt data. In addition, clustering algorithms can be used as well as artificial intelligence techniques to provide the customer with insights and representations of the receipt data retrieved.

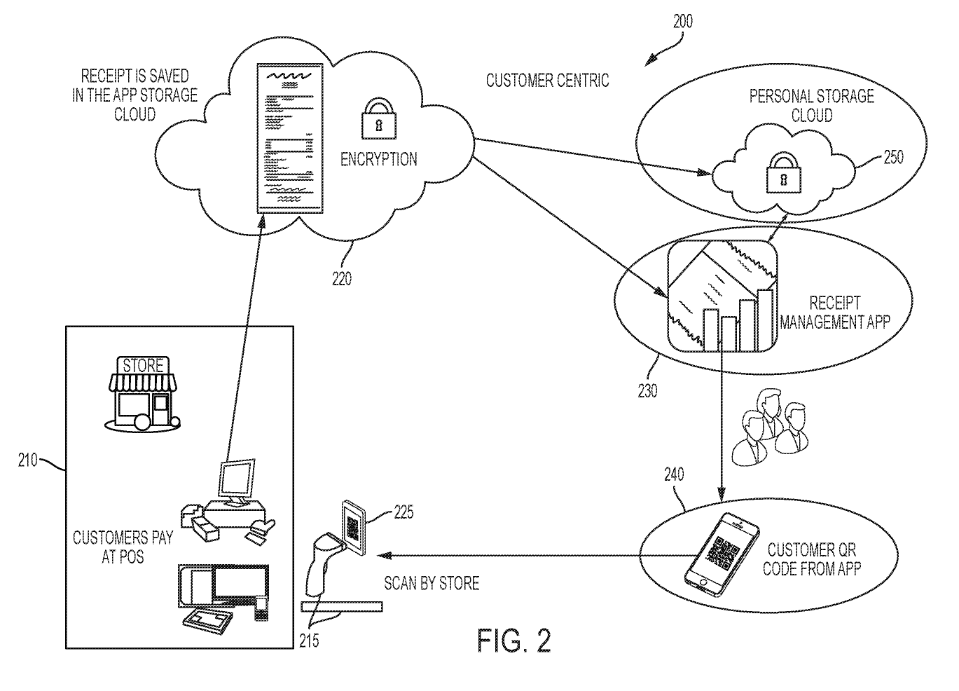

With a reference to FIG. 2, FIG. 2 is an exemplary diagram illustrating scan-able codes generated by the customers for a computing platform using a receipt management app for distributing virtual receipts to customers in accordance with an embodiment. A POS system 210 is coupled to a scanner 215 to capture a scan-able code. A customer using a mobile device 240 generates a scan-able code 225 and presents the scan-able code 225 via the display of the mobile device 240 in a manner that the scan-able code 225 can be scanned or captured by the scanner 215 which is coupled to the POS system 210. Essentially, the display of the scan-able code 225 to the POS system 210 enables a handshake function to occur where the data of the scan-able code 225 is transferred to the POS system 210. In an exemplary example, the scan-able code 225 is a QR-code which is machine readable by the scanner 215 and data from the QR-code is extracted and coupled or merged with the receipt data of the transaction that is performed between the customer and the merchant. The QR-code enables unique identifier information associated with the particular customer performing the transaction and this unique identifier information can be attached to the virtual receipt data to enable a customer using data from the QR-code to identify a record of the virtual receipt at a ledger of records stored in the app storage cloud 220.

The customer may access a receipt management app 230 which is hosted on a client on the mobile device 240 of the customer. The receipt management app 230 will in turn access and retrieve receipt data from the personal storage cloud 250 and the app storage cloud 220. The receipt record uploaded to the app storage cloud 220 may be accessed using the identifier information from the QR-code and matched with the associated record containing the identifier information in the app storage cloud 220. In addition, the personal storage cloud 250 may be configured to access a set of records in the app storage cloud 220 with the identifier information of the QR-code. In this case, the customer by accessing the personal storage cloud 250 would have access to all or most of the customer's virtual receipts which have been uploaded to the app storage cloud 220 with the identifier information added from the QR-code presented.

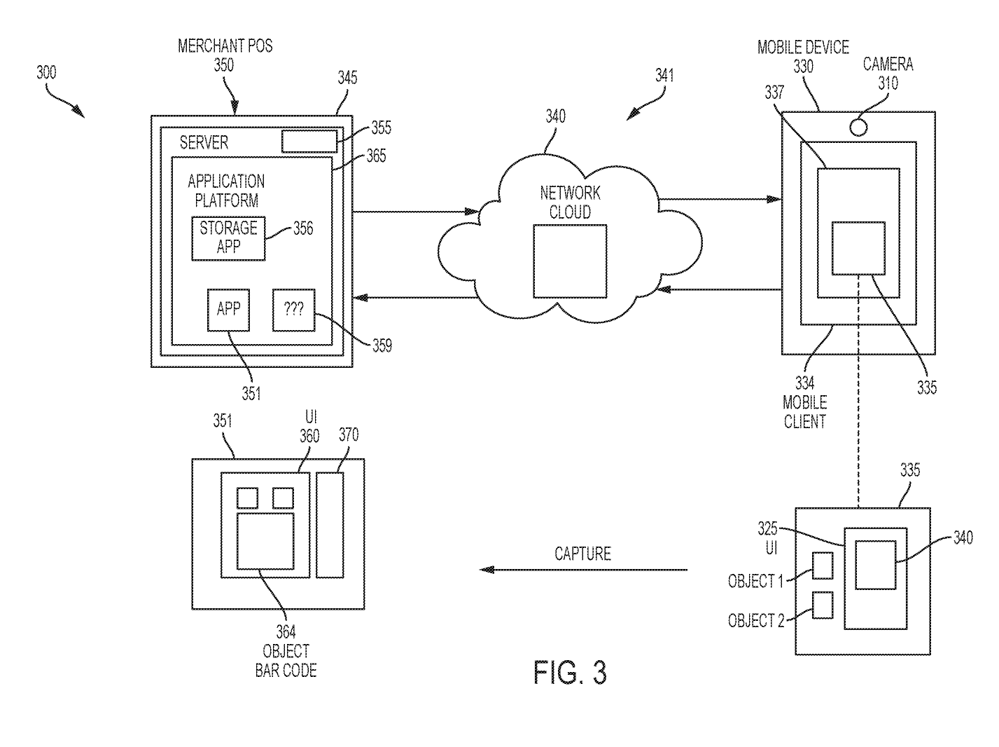

FIG. 3 is an exemplary diagram illustrating a computing platform using a receipt management app of a receipt app client and server system for capturing scan-able codes by customers for a receipt app system for distributing virtual receipts to customers in accordance with an embodiment in accordance with an embodiment. FIG. 3 shows a cloud based network system or platform which may be used for routing virtual receipts where the mobile device 330 is communicating via a network cloud 340 to a server 345 for supporting a receipt management app which operates on-demand by communicating via the network cloud 340 to the mobile device 330 and which is hosted on a hosted app platform on a server 345. The network cloud 340 can include interconnected networks including both wired and wireless networks for enabling communications of the mobile device 330 via a mobile client 334 to the server receipt management app 351 hosted by server 345. For example, wireless networks may use a cellular-based communication infrastructure that includes cellular protocols such as code division multiple access (CDMA), time division multiple access (TDMA), global system for mobile communication (GSM), general packet radio service (GPRS), wide band code division multiple access (WCDMA) and similar others. Additionally, wired networks include communication channels such as the IEEE 802.11 standard better known as Wi-Fi®, the IEEE 802.16 standard better known as WiMAX®, and the IEEE 802.15.1 better known as BLUETOOTH®. The network cloud 340 allows access to communication protocols and application programming interfaces that enable real-time video streaming and capture at remote servers over connections

The mobile device 330 includes the mobile client 334 which may use a mobile software development kit “SDK” platform. This SDK platform can provide one step activation of an on-demand services via the receipt management app 335 such as shown here of the mobile client 334 for activating the on-demand service such as the persona identification app of the present disclosure. The mobile device 330 may include any mobile or connected computing device including “wearable mobile devices” having an operating system capable of running mobile apps individually or in conjunction with other mobile or connected devices. Examples of “wearable mobile devices” include GOOGLE® GLASS™ and ANDROID® watches. Typically, the device will have capabilities such as a display screen, a microphone, speakers and may have associated keyboard functionalities or even a touchscreen providing a virtual keyboard as well as buttons or icons on a display screen. Many such devices can connect to the internet and interconnect with other devices via Wi-Fi, Bluetooth or other near field communication (NFC) protocols.

The mobile client 334 may additionally include other in-apps or apps like the receipt management app 335 as well as SDK app platform tools and further can be configurable to enable downloading and updating of the SDK app platform tools. In addition, the mobile client 334 uses an SDK platform which may be configurable for a multitude of mobile operating systems including ANDROID®, APPLE® iOS, GOOGLE® ANDROID®, Research in Motion's BLACKBERRY OS, NOKIA's SYMBIAN, HEWLET_PACKARD®'s WEBOS (formerly PALM® OS) and MICROSOFT®'s WINDOWS Phone OS

The receipt management app 335 or for that matter an in-app of the mobile client 334 provided on the SDK platform can be found and downloaded by communicating with an on-line application market platform for apps and apps which is configured for the identifying, downloading and distribution of apps which are prebuilt. One such example is the SALESFORCE APPEXCHANGE® which is an online application market platform for apps and apps where the downloading, and installing of the pre-built apps and components such as a receipt management app 335 for the mobile client 334 with receipt management app features.

In addition, these on-line application market platforms include “snap-in” agents for incorporation in the pre-built apps that are made available. The receipt management app 335 may be configured as a “snap-in” agent where the snap-in agent is considered by the name to be a complete SDK packages that allows for “easy to drop” enablement in the mobile client 334 or into webpages.

The server 345 acts as a host and includes the server receipt management app 351 that is configured for access by an application platform 365. The application platform 365 can be configured as a platform as a service (“PaaS) that provides a host of features to develop, test, deploy, host and maintain applications in the same integrated development environment of the application platform. Additionally, the application platform 365 may be part of a multi-tenant architecture where multiple concurrent users utilize the same development applications installed on the application platform 365. Also, by utilizing the multi-tenant architecture in conjunction with the application platform 365 integration with web services and databases via common standards and communication tools can be configured. As an example, SALESFORCE SERVICECLOUD® is an application platform residing on the server 345 that hosts the server receipt management app 351 and may host all the varying services needed to fulfil the application development process of the server receipt management app 351. The SALESFORCE SERVICECLOUD® as an example, may provide web based user interface creation tools to help to create, modify, test and deploy different UI scenarios of the server receipt management app 351.

The application platform 365 includes applications relating to the server receipt management app 351. The server receipt management app 351 is an application that is part of a platform that communications with the mobile client 334, more specifically provides linking for data communications to the mobile client 334 for multimedia data capture and streaming to the server 345. The server receipt management app 351 may include other applications in communication and data discovery for accessing a multi-tenant database 355 as an example, in a multi-tenant database system. In addition, the server receipt management app 351 may include components configurable to include user-interfaces (UI) to display a webpage 360 created or potentially alternative webpage configurations for selection and viewing. In an exemplary embodiment, the display of the webpage 360 may present UIs for displaying the survey results. The SALESFORCE SERVICECLOUD® platform is an application platform 365 for computing that can host applications for creating webpages of UIs for communication with a receipt management app 335 of the mobile client 334.

With continuing reference to FIG. 3, the display of the webpage 360 includes an object 364 representing the scan-able code. Additionally, the application platform 365 has access to other databases for information retrieval which may include a knowledge database 370 that has artificial intelligence functionality 352. In an exemplary embodiment, the SALESFORCE® EINSTEIN™ data discovery app may include data discovery functionality that can be used with data from a SALESFORCE® app for collecting additional types of data related to items or other data of the virtual receipt and can allow for training of deep learning models to recognize and classify data sets of the receipt data received.

In addition, the user can search for the answers using the knowledge database 370 which may be part of the multi-tenant database architecture allowing for communication with the mobile client 334 about the receipt data. The knowledge database 370 may include an object data repository configured to allow the user to browse for information relating to merchant and receipt items and send that information to the webpage 360. In addition, the application platform 365 can access a multi-tenant database 355 which is part of the multi-tenant architecture. The multi-tenant database 355 allows for enterprise customer access, and the application platform 365 may be given access to the multi-tenant database and made dependent upon differing factors such as a session ID associated with the receipt management app session.

With a continued reference to FIG. 3, the mobile device 330 includes a camera 310 and hosts the receipt management app 335 which may also include an app or in-app “snap-in” agent with an UI configured like a button for initiating or terminating a receipt management app's execution when the receipt management app 335 is executing varies steps. The UI button could be shown on a display 325 with the button UI designated as an object within the display 325. The display 325 may also include a UI were other types of media, i.e., any kind of information can be captured, viewed or transmitted by the receipt management app 335.

In an exemplary embodiment and in relation to the diagram of FIG. 1, the receipt management app 335 of FIG. 3 would capture the scan-able code by the camera 310 were the scan-able code may be displayed on the POS device 350 or an associated display (not shown) of the POS device 350 or be printed out and placed in a location so that the customer using the camera 310 can capture the code of the printout or on the display. The scan-able code may be captured in a variety of digital formats including as a raw image, JPEG image, MPEG video, etc. for transcoding and data extraction by video processing solutions of the receipt management app 335 or by calls and procedures of third party image processing solutions. For example, OPENCV or BOOTCV are open source solutions that allow for the capture and processing of image or video data captured.

The receipt management app 335 communicates with the network cloud 340 to access records containing virtual receipt data that may reside in databases 341 in the network cloud 340 or may communicate via the network cloud 340 to databases 356 at the POS or multi-tenant database 355.

The receipt management app 335 may reside on a host such as a mobile device 330 which is different and therefore can be considered agnostic and configurable to the mobile device 330 which performs the hosting. Additionally, the receipt management app 335 can be configured to reside in part or be presented in part on other interconnected devices. An example of this multi-device hosting would be interconnections of smart phones coupled with wearable devices where the display maybe found on an interconnected device or both the mobile and interconnected device.

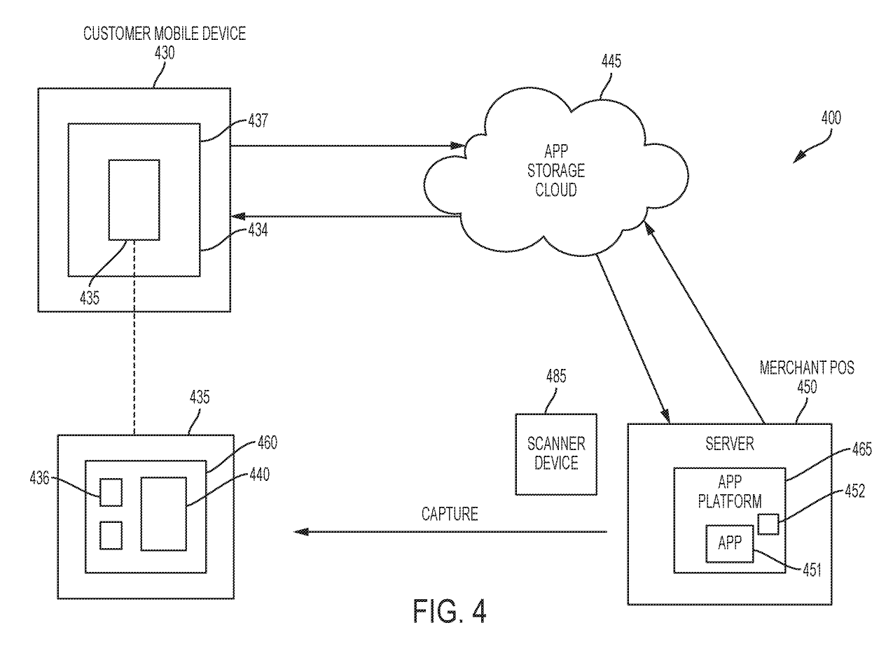

FIG. 4 is an exemplary diagram illustrating a computing platform using a receipt management app of a receipt app client and server system for capturing scan-able codes by merchants for a receipt management app system for distributing virtual receipts to customers in accordance with an embodiment in accordance with an embodiment. In conjunction with the configuration illustrated in FIG. 2, in FIG. 4 the customer by the mobile device 430 actuates the receipt management app 435 to generate a scan-able code 440 and to display the scan-able code 440 on the mobile device 430 of the customer. The receipt management app 435 generates a scan-able code 440 for displaying by the customer to the merchant. The merchant using a scanner 485 coupled to the POS device 450 to scan or capture the scan-able code 440 generated by the customer. The scan-able code 440 generated by the receipt management app 435 is a machine-readable code that includes identifying information of the customer. The receipt management app 435 by actuations of objects 436 via a user interface (UI) 460 allows for access to an app storage cloud 445 containing a database of records of the virtual receipts. Using the identification information generated by the receipt management app 435, the customer can select a record and retrieve a virtual receipt stored in the record which has been generated by the merchant. The POS DEVICE 450 upon capturing of the scan-able code 440 by the scanner 485 generates identification to associate a receipt generated by the POS device 450 with the customer providing the scan-able code 440. That is using a receipt management app 435 the customer generates unique identifier information using time stamp data, random number generation algorithms etc. to create unique identification information of the customer. The unique identification information is then transferred via the scan-able code 440 to the merchant at the POS device 450 of the merchant. The unique identifier created by the customer may be generated on a per transaction basis for each transaction with the merchant, or may be associated with the merchant for all customer transactions with a particular merchant or merchants. Further, the unique identifier information may be temporal or permanent in nature for retrieval of the virtual receipt. In other words, the receipt management app 435 may have a multitude of setting to safeguard the customer's privacy and limits the time of an access of the virtual receipt information by placing limits on the use of the identifier information. The merchant by extracting data associated with the identifier information upon scanning would be notified about the limitations on access and use. Further, the identification information generated by the customer may allow for additional functionality to be triggered, for example by sending of emails to the customer with the virtual receipt data rather than the customer accessing the app storage cloud 445. In other words, in an exemplary embodiment, the customer may associate profile information with the identifier information and set-up alerts or automated emails with file record profiles at the app storage cloud 445 so there is automated generations of virtual receipts which can be sent to the customer at a customer selected email address, cell number etc. In this example, the customer would not have to provide the merchant or for that matter disclose to the merchant any customary identification information such as an email address. Rather, the scan-able code 440 could mask such information without the customer having to provide the information and this, in turn, can provide a layer of security and privacy to the customer yet still allow the customer to have at least, if not more, of a functionality customarily associated with a customer giving an email address to a merchant.

Upon scanning by the merchant, the merchant receipt management app 451 of the POS device 450 of the merchant would upload via the application platform 465 and send receipt data to an app storage cloud 445 designated by the merchant or prior configured by the application platform 465. The merchant may encrypt the data and may in addition add additional information. For example, the application platform may include artificial intelligent and machine learning apps 452 for augmenting the receipt data and adding other useful information. In addition, the merchant may add coupon information or advertising information to the virtual receipt so when the customer accessing the record in the app storage cloud 445 the additional information is displayed. Further, the receipt data sent is not tied to the financial transaction or banking data of the customer, in other words, by using the scan-able code 440, as the link and the only link with the customer; other more confidential information of the customer is not uploaded to the app storage cloud 445. Hence, the merchant and customer even if the app storage cloud 445 is hacked or any of the processing pipeline breached, the identify information is limited only to receipt information and risks and liabilities of both the merchant and customer are limited.

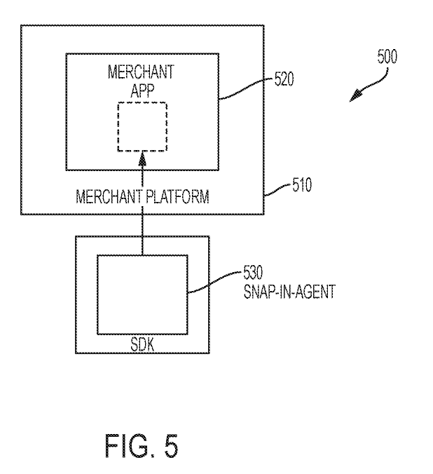

FIG. 5 is an exemplary diagram illustrating a snap-in agent for integrating into a merchant computer platform for using a receipt management app of a receipt app client and server system for generating or capturing scan-able codes by merchants or customer for a receipt app system for distributing virtual receipts to customers in accordance with an embodiment in accordance with an embodiment. Major retailers are developing apps of their own and have a reluctance to use other third party apps in the checkout process as such retailors want to claim the app real estate which associated with a customer of the retailor. That is, these retailors may not be receptive to using alternative third party app platforms other than the app platform that the retailer has developed and distributed to the retailer's customers. Moreover, the retailer may have already gained much customer information and may already be using the platform for distributing coupons, specials and driving revenue from the retailer app to the customers. Hence, in order for wider spread distribution of the receipt management app, the receipt management app may be configured as an app or in-app snap in agent on an SDK platform that can be agnostic in operation to the app platform. That is, the snap-in agent may be downloaded or placed in an already created app or app platform of a merchant for actuation as a separate but integrated module.

FIG. 5 illustrates the merchant app platform 510 on a POS device 500 of the merchant that includes an app 520. The merchant would via the merchant app platform 510 access a third-party computing platform for accessing and retrieving the snap-in-agent 530. The merchant may download or drop and drag the snap-in agent onto the merchant app platform 510 or embed the snap-in agent on the app 520 of the merchant. Hence, the snap-in-agent 530 provides an alternate configuration that allows the merchant to utilize the app 520 which has been already configured of the merchant with the merchant customer base and send virtual receipts to the customer. In other words, the snap-in-agent 530 is added as a resource to the merchant pipeline conveniently with a limited functionality, as example, of linking virtual receipt data from the merchant to the customer. In an exemplary embodiment, the merchant would modify the script of the app 520 to include a data exchange with the snap-in-agent 530 or to add functionality or configurations of the app 520 as the merchant chooses. In other embodiments, the merchant may simply click and paste receipt data into the snap-in-agent 530 or a batch operation may be used at prescribed times to upload all receipt data and customer identification data to the snap-in-agent 530 or the receipt management storage with identifier information extracted by the receipt management app platform.

In an exemplary embodiment, the snap-in-agent 530 may be further configured to use a scan-able code already in use for financial transactions and being displayed by the merchant at the merchant POS. That is, is some instances, the merchant app platform 510 may display a scan-able code at a POS terminal used for payment by the customer. The snap-in-agent 530 may be configured to utilize the scan-able code already displayed by the merchant with unique information at the time of the customer transaction to identifier the customer. For example, the customer when making a financial transaction using the merchant app platform 510 is at a terminal coupled to the POS device of the merchant and can view the scan-able code being displayed on a display of the terminal of the merchant when making the financial transaction. The customer would simply have to scan the scan-able code and the receipt management app of the customer would use the information derived from the scan-able code to generates identifiers corresponding to identifiers generated by the merchant POS to access and receive a virtual invoice record at a third-party database of invoice records. In such instance, the customer would scan or capture the scan-able code displayed and then the receipt management app of the customer would add identifier information such as timestamps, location information, or other similar information by executions of the receipt management app upon the scanning or capture operation. The receipt management app is a separate and independent app then the payment applications used by the merchant which the customer uses for payment.

In an exemplary embodiment, a snap-in agent incorporated in the payment app for accessing the receipt management app of the merchant or a server connected to the receipt management app platform. In addition, the merchant may configure the receipt management app with options were the customer may choose to use a separate app to receive the virtual receipt information or may simply execute a snap-in-agent 530 that is embedded in a transactional app used with a transaction with the merchant. Further, the snap-in-agent 530 may be configured to use the scan-able code information that is scanned during the financial transaction. In other words, a one-step scanning process of the scan-able code would suffice and the snap-in-agent can capture the merchant identifier of the scan-able code and then add additional unique information of the transaction creating unique labels that are identifiable only by the customer and merchant such as time stamps etc. to uniquely label the record of the virtual receipt for further retrieval at a later stage.

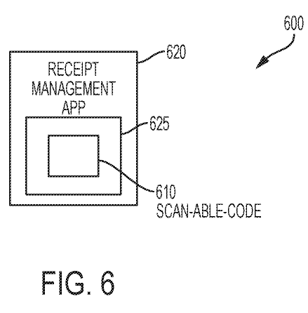

FIG. 6 is an exemplary embodiment of a scan-able code already in use by a merchant or customer which may be associated with receipt management app, in accordance with an embodiment. A customer may already be using a QR-code with a particular social media app platform, computer application, or app and may want to use the same scan-able code for customer identification. In an exemplary embodiment, the receipt management app 620 would include a user interface 625 for retrieving the QR-code already in use by the customer as a unique identifier of the transaction and for associating with the particular transaction with the merchant POS system. That is, using the user interface 625 of the receipt management app 620, the customer may select, use a drop-in window, upload or incorporate by other means the QR-code already in use by the customer with the other social media app platform, computer application or app; and enable the QR-code to be used as the customer identifier of the customer in the particular merchant transaction and for accessing the receipt data in the cloud repository. In this example, the customer would incorporate the QR-code 610 already in use into the receipt management app 620 and display the QR-code 610 to the merchant at the merchant POS during the transaction with the merchant. The merchant would similarly scan the QR-code 610 and use the QR-code 610 as the customer identifier for the particular transaction and generate a particular identifier at the receipt depository for access by the customer using the QR-code 610 already in use. In other words, the customer would simply access the QR-code 610 which the customer is accustomed to using and use this code for accessing the receipt information. Hence, the receipt management app is configurable to use a multitude of different scan-able codes so long as the scan-able code allows for identifying data to be extracted with a particular customer who is performing the transaction with the merchant and the identifying data extracted allows for a corresponding set of identifying data for use by the customer to access and retrieve the receipt record uploaded by the merchant to the app cloud storage. In an exemplary embodiment, with an integration with a social media app with the receipt management app, the social media app may be used to scan the QR-code and the virtual receipt may be stored locally or in the social media app personal cloud.

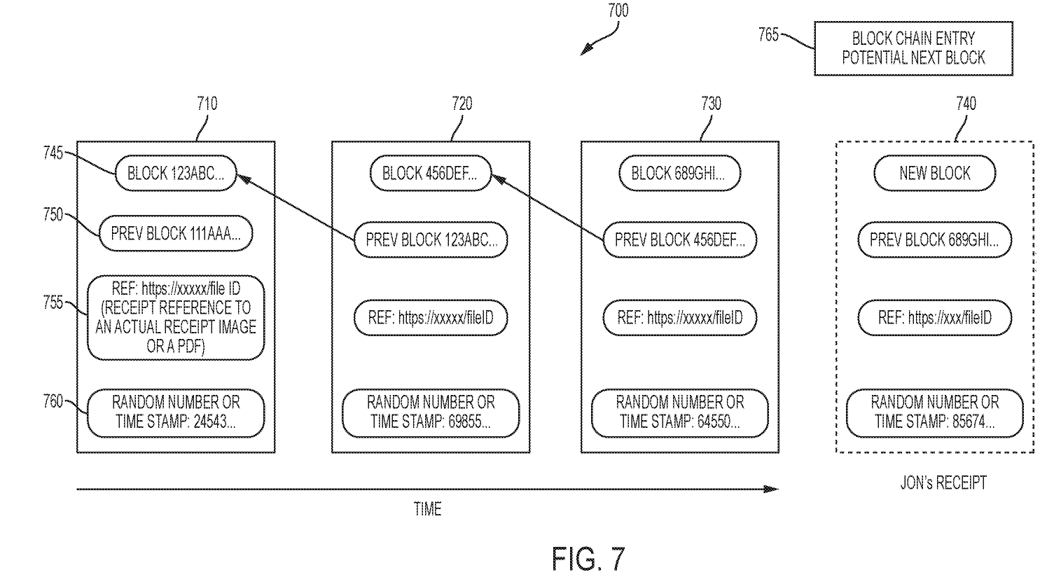

FIG. 7 is an exemplary flowchart illustrating a computing platform using a blockchain ledger 700 for storing data of a receipt management app of a receipt app client and server system for capturing scan-able codes by merchants for a receipt app system for distributing virtual receipts to customers in accordance with an embodiment in accordance with an embodiment. FIG. 7 illustrates a blockchain ledger 700 of a blockchain exchange with a blockchain ledger entry 765 for adding a data block 740 to the blockchain ledger 700. The blockchain ledger entry 765 is alternatively referred to as the adding of blockchains to the blockchain database. Further, adding blocks to an individual blockchain or the ledger or database is referred to as mining. In the blockchain ledger 700, the entry process includes a three-step process of execution by a processing module of a consensus validation if the entry meets the terms of the contract, the entry is then committed to the blockchain ledger and all parties have the same ledger. This process is illustrated at the origination of the blockchain which includes the blockchain hash of the packet header information 745 of a data block 710 and the data of image of the receipt data 755 and the data of the unique random number/time stamp 760.

The data or block is then reviewed by participants (or has an automated review) of the blockchain ledger 700 who by consensus either validate or not the data to be appended to the blockchain. The block of data to be appended is shown in the data blocks 710, 720, 730 and 740 which includes the packet header information 745 of a present or added data block and header information 750 of a previous block identifying the block, time of entry, and an associated hash which is a unique identifier that identifies the data block in relation to the previous data block added. In other words, because the hash is based on the previous hash and in addition ties each block of the blockchain ledger 700 together the hash is unique and non-corruptible. Hence, it is not possible to insert false blocks or corrupt the blockchain because each new hash builds on the former hash. Therefore, each data block is a permanent record of the receipt transaction. By the reference to a previous data block by the previous hash, which is a hash of the previous block header; this reference connects each data block to the parent of the data block, and therefore by induction to all previous data blocks. The header items are hashed into the data block hash, which allows for proof that the other parts of the header have not been changed, and this hash is also used as a reference by the succeeding data block.

The other pertinent part of the data block 710 is the payload which is designated as the receipt data 755. In this particular case, the identifier is information of the transaction of the receipt sent to the data block 710 of the unique random number/time stamp 760. However, the payload is not simply limited to the receipt data or identifier data but may include other data or even ancillary data. In an exemplary embodiment, the data maybe ancillary data from other sources which may include data from third parties, data generated by processing or artificial intelligence or machine learning techniques. The data block 710 is or may then be distributed to other databases where the data block 710 is replicated in other databases (not shown). The data block 710 may be additionally replicated in additional connected databases. In an exemplary embodiment, the connected database 320 and the other databases may be deployed in a network database configuration of multi-tenant connected databases where each participant has access to various tenant databases storing the data block 710 in blockchains. The benefits of the blockchain ledger use and data entry are multi-fold and are the result of data redundancies, validation processes, fixed unalterable recordation of the data, transparency of the records, obstacles to unauthorized data entry, prioritization of participants, and advance notification features.

In an exemplary embodiment, high level pseudo-code for implementation of the blockchain ledger 700 is as follows:

class CloudStorageManager
{
private CloudStorageAccount storageAccount;
private CloudBlobClient blobClient;
public CloudBlobContainer container;
// Credential: using Storage Shared Access Signatures (SAS) token.
// SAS has limited access to objects in the storage account,
// thus no account key exposing.
// AccountName: the storage account name, for example: StorageAccount
// CloudStorageContainer: the container name in the storage account
// For example: DigiReceipt
public CloudStorageManager
(string Credential, string AccountName, string CloudStorageContainer)
{
StorageCredentials storageCredentials =
new StorageCredentials(Credential);
storageAccount =
new CloudStorageAccount(storageCredentials, AccountName, null, true);
blobClient = storageAccount.CreateCloudBlobClient( );
container = blobClient.GetContainerReference(CloudStorageContainer);
// Blob¬level public access.
// Anonymous clients can read blob data within this container,
// but not container data.
container.SetPermissions(
new BlobContainerPermissions { PublicAccess =
BlobContainerPublicAccessType.Blob }
);
}
public bool UploadFile(string localFileName)
{
var blobName = CreateBlobNameFromFile(localFileName);
// above example: “dReceipt_salesforce_1497887439.jpg”
// dReceipt_<company name>_timestamp.jpg
CloudBlockBlob blockBlob =
container.GetBlockBlobReference(blobName);
blockBlob.Properties.ContentType = “image/png”;
// add Metadata to the file, information will be passed. Below is
an example //
¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬
¬¬¬¬¬¬¬¬¬¬¬¬
blockBlob.Metadata.Add(“Source”, “Salesforce.com”);
// checkout company,
// eg Retailer 1, Retailer 2 blockBlob.Metadata.Add(“StoreId”,
“FL_10009”);
// checkout store, eg FL Deerfield Beach Store
blockBlob.Metadata.Add(“AdminId”, “23490”);
// checkout administration blockBlob.Metadata.Add(“Station”, “s01”);
// checkout station blockBlob.Metadata.Add(“Date”,
“2006¬04¬17T21:22:48.2698750Z”);
// checkout UTC time blockBlob.Metadata.Add(“More_Key”,
“More_Value”);
// more info //
¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬¬
¬¬¬¬¬¬¬¬¬¬¬¬
}

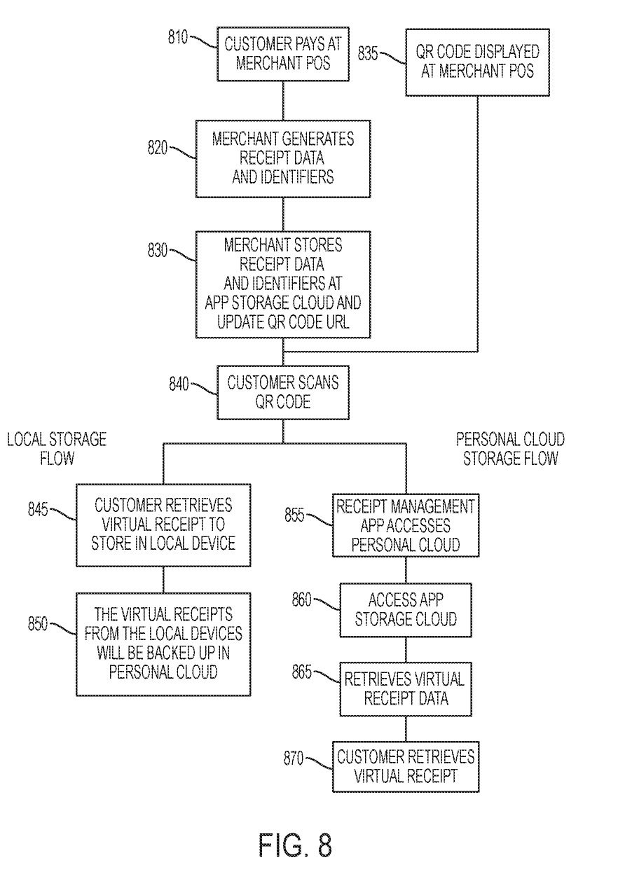

FIG. 8 is an exemplary flowchart illustrating a computing platform using a receipt management app for capturing scan-able codes by customers for a receipt app system for distributing virtual receipts to customers in accordance with an embodiment in accordance with an embodiment. With a reference to FIG. 8, a store centric flow is described where the prerequisites are as follows: the customer has the mobile app of the receipt management app installed on the customer's smartphone; and the merchant has attached or displayed a dynamic QR-code near the checkout section and it is in a location that is convenient and available for the customer to scan the QR-code. The customer selects the items to buy in the store and is ready to purchase the items at checkout station which is a designated merchant POS. Once the payment is made to the merchant, the customer will be given an option to opt for a virtual receipt or printout form of receipt or both. If the customer opts for the virtual receipt or both, the merchant will upload the receipt data to the receipt management app storage cloud from the POS device using the receipt management app of the merchant. The customer will scan the QR-code near the checkout area using the mobile app to download the virtual receipt from the receipt management storage cloud to the mobile device of the customer. Hence, other than scanning the QR-code, no other information is exchanged with the customer and the merchant; and further, the customer can independently using the receipt management app of the customer access and receive the receipt data from the receipt management cloud.

In the flowchart of FIG. 8, at task 810, the customer pays or performs a transaction for an article or service at a merchant POS. As discussed, the customer mobile device, i.e. smart phone will have the capability and processing for the receipt management app. The receipt management app of the customer on the smart device can have capabilities including the ability to store all the receipts and organize based on the merchant establishment, date of the transaction, month and years cumulative of transactions and further export transactional data to various accounting programs for further analysis or to share with social networks. The receipt management app of the customer is connected to a mobile app storage which is in turn connected to a personal cloud having an account database associated with the customer. The personal cloud may be used to backup and restore the receipts locally stored at the smart device. At task 810, the receipt management app is enabled to scan or capture the QR-code or extract data from the QR-code by the camera and processing solutions of the smartphone. Additionally, in an alternate embodiment, the receipt management app can display a QR-code for capture by the merchant at the POS using a scanning device associated with a transactional processor of the merchant POS or a separate scanning device. The smartphone receipt management app may also include an analytics engine and may have analytics tools for monitoring and analyzing receipt data. In addition, the receipt management app will have accessible details on customer purchases which may enable predictive searches or offerings by merchants to the customers of items, services and special offers. This will also provide incentives for merchants to use the receipt management platform as it will provide an avenue for merchants to offer offering to customers directly. In addition, the receipt management app may attract merchants and retailer with placements of displays in the receipt management app interface of advertising related to product and service offering. At task 830, the customer captures or scans the QR-code using the smartphone camera.

In an exemplary embodiment, the QR-code may include data related to an URL which contains the customer's user ID and UID for instructions for a one-time use. For example, a data structure of the URL with the user ID and UID may be defined as follows: http:digireceipt.com/connect/qconnect?userid=USERID&UID=some_UID.

At task 820, the merchant POS generates receipt data and identifiers associated with the particular customer of the transaction such as receipt data related to items or services purchases by the customer and identifiers such as timestamp information when the transaction is performed. At task 830, the merchant stores the receipt data and identifiers at the app storage cloud. In addition, at task 830 any updates related to the receipt or transaction data may also be stored at the app storage cloud including an updated QR code URL. The app storage cloud is encrypted and accessible by the merchant and the particular record is also accessible by the customer using the receipt management app and the data extracted from the captured QR-code which may link to the updated QR code URL. The app storage cloud, in addition, may be configured in a number of ways to contain the receipt data of all the merchant customers, limited to a particular store, or limited to a particular period. In some instances, the receipt information is saved in the block ledger of a database of the app storage cloud. In an alternative exemplary embodiment, a notification may be sent from the server of the app storage cloud to the receipt management app of the local client of the customer notifying the customer of the receipt record. In addition, in the alternative exemplary embodiment the customer may be asked to confirm the transaction and this may also provide an additional level of security against fraudulent transactions. The app storage cloud stores the receipt information once the customer has consummated the transaction or paid for the transaction.

At task 840, the customer scans the QR code. That is, at task 835, the QR code is displayed at the merchant POS for scanning or capture by the client. If the customer elects for a virtual receipt, the customer at task 840 would scan the QR-code. If the customer, does not elect for a virtual receipt, the customer would simply choose not to scan the QR-code. In other words, the customer's actions dictate whether or not the customer chooses to receive the virtual receipt and does not have to make any voluntary requests. Hence, the virtual receipt request is indirectly seamless integrated into the transaction process when the customer performs the transaction with the merchant. There is no significant steps or latency time added to the transaction process. Moreover, there is no disclosure made to the merchant other than the customer scanning the QR-code displayed by the merchant. Hence, potential privacy concerns or divulging of information on the part of the customer are not raised and are prevented by this seamless scanning operation on the part of the customer limiting the interaction with the merchant on whether or not the customer wants a virtual receipt and the information shared by the customer to receive the virtual receipt. In an alternative embodiment, once the payment is made by the customer and the customer has agreed to receive a virtual receipt, the merchant then may save the receipt to the encrypted storage cloud.

The merchant at task 830, stores the receipt with a date and time stamp, store related info, customer info and purchase info which also leverages the blockchain ledger hash scheme to ensure the data integrity on the app storage cloud for both security and authenticity. Since the hash of a block of a blockchain (i.e. a “fingerprint” of a block of a transaction) is timestamped and references the previous hash which the present hash is built upon and is recorded in the block header of the subsequent block into the blockchain, every block in the blockchain is immutable. If a customer return items using a manipulated receipt, the “fingerprint” associated with the block will not be the same as the original data or legitimate data and the merchant will know the receipt has been changed. Hence the customer cannot change the transaction data of the receipt and counterfeit or fraudulent returns on the part of the customer are eliminated. By the use of the blockchain ledger, the receipt data is permanent and not changeable and immediate notice of a potential fraudulent return attempt is given to the merchant by a difference in the record of the blockchain and the receipt presented by the customer.

At task 845, in a local storage flow scheme, the customer can retrieve the virtual receipt to store in a local device. For example, the customer can access the virtual receipt and can download this receipt by scanning a dynamic QR-code at the merchant counter in the store. The virtual receipt availability in the app storage cloud can be configurable and can exist for a given period and can be set by the merchant or customer. At task 850, the virtual receipts from the local devices of the customer can be backed up in a personal cloud associated with device or receipt management app or other third-party app such as a social media app. In addition, the virtual receipts may be displayed locally on the local device of a smartphone or the like, or for sending to a third party or for any other number of functions etc.

At task 855, in a personal cloud storage flow scheme, the receipt management app access a personal storage cloud to retrieve the virtual receipt via the personal storage cloud. At task 860, the receipt management app may access the app storage cloud. At task 865, the customer may retrieve virtual receipt data. At task 870, the customer may retrieve the virtual receipt for display etc.

In an alternate exemplary embodiment, if a customer wanted to return an item, the customer could electronically display the receipt to the merchant or the merchant could use receive a notification from the receipt management app from the customer and access the receipt data independently. Additionally, the customer may be able to display identifier information to the merchant for capture such a QR-code generated from the receipt management app of the customer to access the receipt in the app storage cloud which in instances may be configured as a block chain ledger.

In another alternate exemplary embodiment, once the payment is made, the merchant scans the QR-code generated in a customer receipt management app to identify the app and customer information. Using this process the receipts from the receipt management app cloud may be locally stored in the memory of the smartphone of the customer. In another embodiment, a personal storage cloud will be allocated to the same account of the receipt management app and this will also be used for receipt storage. This personal storage cloud will also be used to backup and restore the contents of the receipt data record.

In yet another alternate exemplary embodiment, after the customer pays or performs a transaction for an article or service at a merchant POS, the merchant may generate receipt data and identifiers. Next, the merchant may store the receipt data and the identifiers at the app storage cloud directly. In such instance, when the customer scans the QR-code the customer may retrieve the virtual receipt and store the virtual receipt locally at the device or at a personal cloud storage. The receipt data and the identifiers of metadata, timestamps etc. stored may have storage options configured with expiration periods, for example one month, six months, one year etc.

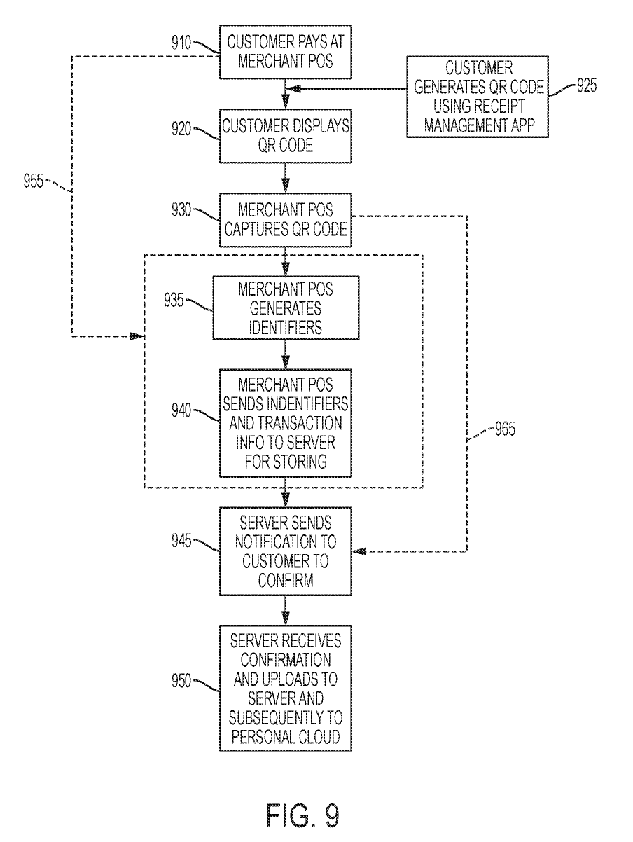

FIG. 9 is an exemplary flowchart illustrating a computing platform using a blockchain ledger for storing data of a receipt management app of a receipt app client and server system for capturing scan-able codes by merchants for a receipt app system for distributing virtual receipts to customers in accordance with an embodiment. With a reference to FIG. 9, a customer centric flow is described with a set of prerequisites as follows: the customer has the mobile app of the receipt management app installed on the customer smartphone or mobile device. The customer executes or has executed the receipt management app at or prior to the transaction with the merchant and created a QR-code which is associated with the customer. In instances, the customer may create the QR-code in advance and may simply have to retrieve the QR-code for display to the merchant stored in the smartphone (i.e. in the passport section as an example). Alternately, the customer may have a print-out of the QR-code for display to the merchant at checkout. The customer may display the QR-code using a variety of displays including the display of the smartphone, the mobile device or a wearable device. The merchant's POS device is equipped with a scanning device or other attachment capable of capturing, reading or extracting the QR-code or data from the QR-code from the customer's smartphone when displayed or conveyed by other electronic means by the customer to the merchant POS.

In FIG. 9, at task 910, the customer selects the items for purchase in the store and is ready to pay at the checkout at the merchant POS. At task 920, once the payment is made and the transaction is consummated, the customer may request the cashier send a virtual receipt instead of printing out a physical receipt or may request both a virtual receipt and printout. Alternately, the customer may make no requests and simply display the QR-code during the checkout for scanning and capture by the merchant POS which will instruct the merchant accordingly. At task 925, the customer generates the QR-code from the receipt management app. That is, prior to the checkout, the customer would have downloaded the receipt management app, set up a customer account with a user id associated with the customer and password. The customer may also choose a set of pre-set configurations or use a default configuration for the set-up. After, the initial set, the customer generates at task 925 the QR-code from the receipt management app. At task 930, the merchant scans the QR-code which the customer displays at task 920. At task 935, the merchant receives via the scanning or capture operation of the QR-code, the customer identifier information for association with a record which the merchant creates by the merchant receipt management app. At task 940, the merchant uploads in a block ledger in an app storage cloud, the customer identifier information and transaction information. After which at task 945, the server depending on the configuration, may confirm the upload of the virtual receipt to a personal cloud of the customer.

In an exemplary embodiment, the merchant receives via the receipt management app, a one-time access token which is generated by the merchant first providing an app ID and/or encrypted code and UID code or QR-Code in a posting of a request as follows:

https://digitalreceipts.com/personal_cloud?USERID:xyz&TOKEN=ACCESS_TOKEN. After the merchant's receipt management app receives the request of the access token, in response a send upload receipt file request to the customer's personal cloud is executed. For example, a send request is executed as follows: post https://digitalreceipts com/personal_cloud?USERID:xyz&TOKEN=ACCESS_TOKEN. When the server receives the upload file request, the server may trigger a notifier to the mobile device of the customer of the request or may use a notification service.

In an exemplary embodiment, the server may use a push notification services to send a notification request to the customer mobile device via the receipt management app of the mobile device. The customer may be requested to confirm the notification request with a message such as “get new receipt Y/N”. After confirming with the customer, the virtual receipt may be uploaded to the personal cloud and can be accessed via the receipt management app of the customer on the mobile device.

Hence, once the merchant stores the virtual receipt at the app storage cloud, from the POS merchant device or terminal, the customer may open his or her mobile receipt management app and will be shown the URL and customer QR-code with related information (i.e. userId and date/time) in receipt management app. By the merchant scanning the QR-code from the customer's smartphone, the virtual receipt is pushed from app storage cloud to the customer's local device or smartphone. In an exemplary embodiment, the SALESFORCE EINSTEIN™ application may be communicated with to receipt data being received by the customer to add related information using artificial intelligent and machine language techniques to augment receipt information received by the customer.

In an exemplary embodiment, the receipt management app may have intelligence on analyzing the receipts and the expenditures of the customer. For example, the receipt management app may notify the customer about other or better options for purchase. In addition, the receipt management app may inform the customer about information on frequently bought items such as sales, where to find better prices, better deals, similar products etc. Also, recommendations for a card or brand or store may be sent to the customer, and in addition, the necessary customer information may be conveniently transposed with the card recommendations. Additionally, the receipt management app may be used to assist a customer in a budget of expenditures. The SALESFORCE EINSTEIN™ application can be integrated or communicated with to provide such advanced artificial intelligence features. For example, the SALESFORCE EINSTEIN™ has sales analytics tools that may be used here as well as discovery tools to provide such features including presenting visual enhancements and trend monitoring.

In an alternative exemplary embodiment, after task 910, when the customer pays at the merchant POS, the identifiers of the virtual receipt directly generated at task 935 via flow 955 and sent by the merchant POS to the server for storing at task 940. In yet another alternate exemplary embodiment, the merchant POS at task 930 captures the QR-code and requests or instructs via flow 965 the server at task 945 to send a notification to the customer to confirm the merchant to perform the task 940 and the subsequent task 940 of generating the identifiers of the virtual receipt and uploading the identifiers and transaction info to the server for storing. In other words, in this embodiment, customer confirmation is required prior to the identifiers and transaction information being generated and uploaded to the server.

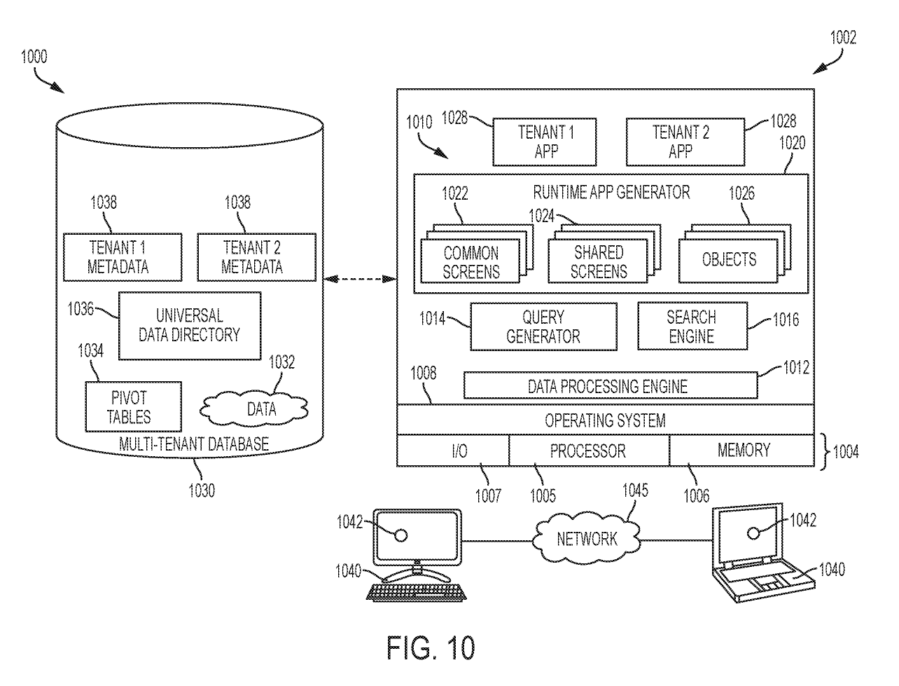

With a reference to FIG. 10, FIG. 10 is a schematic block diagram of a multi-tenant computing environment for use in conjunction with receipt management app in accordance with an embodiment. A server may be shared between multiple tenants, organizations, or enterprises, referred to herein as a multi-tenant database. In the exemplary disclosure, software app services are provided via a network 1045 to any number of tenant devices 1040, such as desk tops, laptops, tablets, smartphones, Google Glass™, and any other computing device implemented in an automobile, aircraft, television, or other business or consumer electronic device or system, including web tenants.

Each application 1028 is suitably generated at run-time (or on-demand) using a common type of application platform 1010 that securely provides access to the data 1032 in the multi-tenant database 1030 for each of the various tenant organizations subscribing to the service cloud 1000. In accordance with one non-limiting example, the service cloud 1000 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 1030. In this regard, each tenant includes one or more users and/or groups associated with, authorized by, or otherwise belonging to that respective tenant. Stated another way, each respective user within the multi-tenant system of the service cloud 1000 is associated with, assigned to, or otherwise belongs to a particular one of the plurality of enterprises supported by the system of the service cloud 1000.

Each enterprise tenant may represent a company, corporate department, business or legal organization, and/or any other entities that maintain data for particular sets of users (such as their respective employees or customers) within the multi-tenant system of the service cloud 1000. Although multiple tenants may share access to the server 1002 and the multi-tenant database 1030, the particular data and services provided from the server 1002 to each tenant can be securely isolated from those provided to other tenants. The multi-tenant architecture therefore allows different sets of users to share functionality and hardware resources without necessarily sharing any of the data 1032 belonging to or otherwise associated with other organizations.

The multi-tenant database 1030 may be a repository or other data storage system capable of storing and managing the data 1032 associated with any number of tenant organizations. The multi-tenant database 1030 may be implemented using conventional database server hardware. In various embodiments, the multi-tenant database 1030 shares the processing hardware 1004 with the server 1002. In other embodiments, the multi-tenant database 1030 is implemented using separate physical and/or virtual database server hardware that communicates with the server 1002 to perform the various functions described herein.

In an exemplary embodiment, the multi-tenant database 1030 includes a database management system or other equivalent software capable of determining an optimal query plan for retrieving and providing a particular subset of the data 1032 to an instance of application (or virtual application) 1028 in response to a query initiated or otherwise provided by an application 1028, as described in greater detail below. The multi-tenant database 1030 may alternatively be referred to herein as an on-demand database, in that the multi-tenant database 1030 provides (or is available to provide) data at run-time to on-demand virtual applications 1028 generated by the application platform 1010, as described in greater detail below.

In practice, the data 1032 may be organized and formatted in any manner to support the application platform 1010. In various embodiments, the data 1032 is suitably organized into a relatively small number of large data tables to maintain a semi-amorphous “heap”-type format. The data 1032 can then be organized as needed for a particular virtual application 1028. In various embodiments, conventional data relationships are established using any number of pivot tables 1034 that establish indexing, uniqueness, relationships between entities, and/or other aspects of conventional database organization as desired. Further data manipulation and report formatting is generally performed at run-time using a variety of metadata constructs. Metadata within a universal data directory (UDD) 1036, for example, can be used to describe any number of forms, reports, workflows, user access privileges, business logic and other constructs that are common to multiple tenants.

Tenant-specific formatting, functions and other constructs may be maintained as tenant-specific metadata 1038 for each tenant, as desired. Rather than forcing the data 1032 into an inflexible global structure that is common to all tenants and applications, the multi-tenant database 1030 is organized to be relatively amorphous, with the pivot tables 1034 and the metadata 1038 providing additional structure on an as-needed basis. To that end, the application platform 1010 suitably uses the pivot tables 1034 and/or the metadata 1038 to generate “virtual” components of the virtual applications 1028 to logically obtain, process, and present the relatively amorphous data from the multi-tenant database 1030.

The server 1002 may be implemented using one or more actual and/or virtual computing systems that collectively provide the dynamic type of application platform 1010 for generating the virtual applications 1028. For example, the server 1002 may be implemented using a cluster of actual and/or virtual servers operating in conjunction with each other, typically in association with conventional network communications, cluster management, load balancing and other features as appropriate. The server 1002 operates with any sort of processing hardware 1004 which is conventional, such as a processor 1005, memory 1006, input/output features 1007 and the like. The input/output features 1007 generally represent the interface(s) to networks (e.g., to the network 1045, or any other local area, wide area or other network), mass storage, display devices, data entry devices and/or the like.

The processor 1005 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 1006 represents any non-transitory short or long term storage or other computer-readable media capable of storing programming instructions for execution on the processor 1005, including any sort of random access memory (RAM), read only memory (ROM), flash memory, magnetic or optical mass storage, and/or the like. The computer-executable programming instructions, when read and executed by the server 1002 and/or processors 1005, cause the server 1002 and/or processors 1005 to create, generate, or otherwise facilitate the application platform 1010 and/or virtual applications 1028 and perform one or more additional tasks, operations, functions, and/or processes described herein. It should be noted that the memory 1006 represents one suitable implementation of such computer-readable media, and alternatively or additionally, the server 1002 could receive and cooperate with external computer-readable media that is realized as a portable or mobile component or platform, e.g., a portable hard drive, a USB flash drive, an optical disc, or the like.

The application platform 1010 is any sort of software application or other data processing engine that generates the virtual applications 1028 that provide data and/or services to the tenant devices 1040. In a typical embodiment, the application platform 1010 gains access to processing resources, communications interface and other features of the processing hardware 1004 using any sort of conventional or proprietary operating system 1008. The virtual applications 1028 are typically generated at run-time in response to input received from the tenant devices 1040. For the illustrated embodiment, the application platform 1010 includes a bulk data processing engine 1012, a query generator 1014, a search engine 1016 that provides text indexing and other search functionality, and a runtime application generator 1020. Each of these features may be implemented as a separate process or other module, and many equivalent embodiments could include different and/or additional features, components or other modules as desired.

The runtime application generator 1020 dynamically builds and executes the virtual applications 1028 in response to specific requests received from the tenant devices 1040. The virtual applications 1028 are typically constructed in accordance with the tenant-specific metadata 1038, which describes the particular tables, reports, interfaces and/or other features of the particular application 1028. In various embodiments, each virtual application 1028 generates dynamic web content that can be served to a browser or other tenant program 1042 associated with its tenant device 1040, as appropriate.

The runtime application generator 1020 suitably interacts with the query generator 1014 to efficiently obtain data 1032 from the multi-tenant database 1030 as needed in response to input queries initiated or otherwise provided by users of the tenant devices 1040. In a typical embodiment, the query generator 1014 considers the identity of the user requesting a particular function (along with the user's associated tenant), and then builds and executes queries to the multi-tenant database 1030 using system-wide metadata 1036, tenant specific metadata, pivot tables 1034, and/or any other available resources. The query generator 1014 in this example therefore maintains security of the common database by ensuring that queries are consistent with access privileges granted to the user and/or tenant that initiated the request.

With continued reference to FIG. 10, the bulk data processing engine 1012 performs bulk processing operations on the data 1032 such as uploads or downloads, updates, online transaction processing, and/or the like. In many embodiments, less urgent bulk processing of the data 1032 can be scheduled to occur as processing resources become available, thereby giving priority to more urgent data processing by the query generator 1014, the search engine 1016, the virtual applications 1028, etc.

In exemplary embodiments, the application platform 1010 is utilized to create and/or generate data-driven virtual applications 1028 for the tenants that they support. Such virtual applications 1028 may make use of interface features such as custom (or tenant-specific) screens 1024, standard (or universal) screens 1022 or the like. Any number of custom and/or standard objects 1026 may also be available for integration into tenant-developed virtual applications 1028. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 1032 associated with each virtual application 1028 is provided to the multi-tenant database 1030, as appropriate, and stored until it is requested or is otherwise needed, along with the metadata 1038 that describes the particular features (e.g., reports, tables, functions, objects, fields, formulas, code, etc.) of that particular virtual application 1028. For example, a virtual application 1028 may include a number of objects 1026 accessible to a tenant, wherein for each object 1026 accessible to the tenant, information pertaining to its object type along with values for various fields associated with that respective object type are maintained as metadata 1038 in the multi-tenant database 1030. In this regard, the object type defines the structure (e.g., the formatting, functions and other constructs) of each respective object 1026 and the various fields associated therewith.

Still referring to FIG. 10, the data and services provided by the server 1002 can be retrieved using any sort of personal computer, mobile telephone, tablet or other network-enabled tenant device 1040 on the network 1045. In an exemplary embodiment, the tenant device 1040 includes a display device, such as a monitor, screen, or another conventional electronic display capable of graphically presenting data and/or information retrieved from the multi-tenant database 1030, as described in greater detail below.

Typically, the user operates a conventional browser application or other tenant program 1042 executed by the tenant device 1040 to contact the server 1002 via the network 1045 using a networking protocol, such as the hypertext transport protocol (HTTP) or the like. The user typically authenticates his or her identity to the server 1002 to obtain a session identifier (“Session ID”) that identifies the user in subsequent communications with the server 1002. When the identified user requests access to a virtual application 1028, the runtime application generator 1020 suitably creates the application at run time based upon the metadata 1038, as appropriate. However, if a user chooses to manually upload an updated file (through either the web based user interface or through an API), it will also be shared automatically with all of the users/devices that are designated for sharing.

As noted above, the virtual application 1028 may contain Java, ActiveX, or other content that can be presented using conventional tenant software running on the tenant device 1040; other embodiments may simply provide dynamic web or other content that can be presented and viewed by the user, as desired. As described in greater detail below, the query generator 1014 suitably obtains the requested subsets of data 1032 from the multi-tenant database 1030 as needed to populate the tables, reports or other features of a particular virtual application 1028. In various embodiments, application 1028 embodies the functionality of an interactive performance review template linked to a database of performance metrics, as described below in a connection with FIGS. 1-8.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 10 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with viewing, object identification, sharing and information retrieving processes between the mobile client and agent in video-chat applications may be performed by software, hardware, firmware, or any combination thereof. For illustrative purposes, the following description of data capture, behavior, roles, tasks, functions, survey, persona, and process may refer to elements mentioned above in connection with FIGS. 1-10. In practice, portions of process of FIGS. 1-10 may be performed by different elements of the described system, e.g., mobile clients, server, cloud, app applications etc.

It should be appreciated that process of FIGS. 1-10 may include any number of additional or alternative tasks, the tasks shown in FIGS. 1-10 need not be performed in the illustrated order, and process of the FIGS. 1-10 may be incorporated into a more comprehensive procedure or process having additional functionality not described in detail herein. Moreover, one or more of the tasks shown in FIG. 1-10 could be omitted from an embodiment of the process shown in FIGS. 1-10 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for routing receipts to customers by a merchant using a computing platform, the method comprising:
generating a scan-able code in advance of a transaction by a merchant point of sale (POS) device for capturing by a mobile device of a customer when the merchant performs the transaction with the customer in order for the customer to receive a virtual receipt of the transaction wherein the scan-able code is associated with a particular merchant;
displaying, at the merchant POS device the scan-able code to the customer, for the customer to perform a capture of the scan-able code by using a receipt app of the mobile device of the customer connected to the computing platform when the merchant performs or has performed the transaction with the customer;
generating, by the merchant POS, identifying data for the customer by combining data from the scan-able code with identifying data generated by the merchant POS relating to the transaction wherein the identifying data comprises identifiers of one or more of: time stamp data of the transaction, data about items or services purchased in the transaction; and random data generated by the merchant POS during the time of the transaction and
sending, by the merchant POS using the computing platform, the identifying data to an app cloud storage with the virtual receipt of the transaction wherein the app cloud storage is configured as a block chain ledger to store the virtual receipt wherein the block chain ledger is a permanent ledger preventing changes to the virtual receipt accessible by the customer using identifying data to access the block chain ledger wherein the identifying data is composed of data which is extracted from a scan-able code captured by the customer as well as additional identifiers of identifying data generated by the receipt app of the customer which correlate to the identifiers generated by the merchant POS to enable access to the block chain ledger to receive the virtual receipt.

2. The method of claim 1, wherein the scan-able code comprises a plurality of different types of scan-able codes which include: a quick response (QR) code, a matrix code, a 2-dimensional code, or a universal product code (UPC) code.

3. The method of claim 1, wherein the additional identifying data is generated independently by the receipt app of the customer and configured to enable access to the virtual receipt of the block chain ledger in accordance with the identifiers generated by the merchant POS.

4. The method of claim 1, further comprising:
notifying by the computing platform, when the virtual receipt is sent to the app cloud storage, the receipt app of the virtual receipt for access and to enable receipt of the virtual receipt by the mobile device of the customer.

5. The method of claim 4, further comprising:
responding, upon notifying, to a request to access the virtual receipt and subsequent request to receive the virtual receipt by the customer via the receipt app by sending the virtual receipt via the computing platform to the receipt app of the customer.

6. The method of claim 5, further comprising:
storing, at the mobile device or at a storage cloud associated with receipt app of the customer, the virtual receipt as requested by the receipt app of the customer.

7. The method of claim 1, further comprising:
configuring a block of the chain ledger to include an unique header comprising at least identifying information for linking prior and subsequent blocks and a body of identifiers from the merchant POS for correlating with additional identifiers of the customer and the virtual receipt for storage.

8. A computer program product tangibly embodied in a computer-readable storage device and comprising instructions configurable to be executed by a processor to perform a method for routing virtual receipts using an application platform, the method comprising:
generating a scan-able code in advance of a transaction by a merchant point of sale (POS) device for capturing by a mobile device of a customer when the merchant performs the transaction with the customer in order for the customer to receive a virtual receipt of the transaction wherein the scan-able code is associated with a particular merchant;
displaying, at the merchant POS device the scan-able code to the customer, for the customer to perform a capture of the scan-able code by using a receipt app of the mobile device of the customer connected to the computing platform when the merchant performs or has performed the transaction with the customer;
generating, by the merchant POS, identifying data for the customer by combining data from the scan-able code with identifying data generated by the merchant POS relating to the transaction wherein the identifying data comprises identifiers of one or more of: time stamp data of the transaction, data about items or services purchased in the transaction; and random data generated by the merchant POS during the time of the transaction and
sending, by the merchant POS using the computing platform, the identifying data to an app cloud storage with the virtual receipt of the transaction wherein the app cloud storage is configured as a block chain ledger to store the virtual receipt wherein the block chain ledger is a permanent ledger preventing changes to the virtual receipt accessible by the customer using identifying data to access the block chain ledger wherein the identifying data is composed of data which is extracted from a scan-able code captured by the customer as well as additional identifiers of identifying data generated by the receipt app of the customer which correlate to the identifiers generated by the merchant POS to enable access to the block chain ledger to receive the virtual receipt.

9. The method of claim 8, wherein the scan-able code comprises a plurality of different types of scan-able codes which include: a quick response (QR) code, a matrix code, a 2-dimensional code, or a universal product code (UPC) code.

10. The method of claim 8, wherein the additional identifying data is generated independently by the receipt app of the customer and configured to enable access to the virtual receipt of the block chain ledger in accordance with the identifiers generated by the merchant POS.

11. The method of claim 10, further comprising:
notifying by the computing platform, when the virtual receipt is sent to the app cloud storage, the receipt app of the virtual receipt for access and to enable receipt of the virtual receipt by the mobile device of the customer.

12. The method of claim 11, further comprising:
responding, upon notifying, to a request to access the virtual receipt and subsequent request to receive the virtual receipt by the customer via the receipt app by sending the virtual receipt via the computing platform to the receipt app of the customer.

13. The method of claim 12, further comprising:
storing, at the mobile device or at a storage cloud associated with the receipt app of the customer, the virtual receipt for the customer.

14. The method of claim 8, further comprising:
configuring a block of the chain ledger to include an unique header comprising at least identifying information for linking prior and subsequent blocks and a body of identifiers from the merchant POS for correlating with additional identifiers of the customer and the virtual receipt for storage.

15. A system comprising:
at least one processor; and
at least one computer-readable storage device comprising instructions configurable to be executed by the at least one processor to perform a method for generating virtual receipts, the method comprising:
generating a scan-able code by a merchant point of sale (POS) device for capturing by a mobile device of a customer when the merchant performs the transaction with the customer in order for the customer to receive a virtual receipt of the transaction wherein the scan-able code is associated with a particular merchant;
displaying, at the merchant POS device the scan-able code to the customer, for the customer to perform a capture of the scan-able code by using a receipt app of the mobile device of the customer connected to the computing platform when the merchant performs or has performed the transaction with the customer;
generating, by the merchant POS, identifying data for the customer by combining data from the scan-able code with identifying data generated by the merchant POS relating to the transaction wherein the identifying data comprises identifiers of one or more of: time stamp data of the transaction, data about items or services purchased in the transaction; and random data generated by the merchant POS during the time of the transaction and
sending, by the merchant POS using the computing platform, the identifying data to an app cloud storage with the virtual receipt of the transaction wherein the app cloud storage is configured as a block chain ledger to store the virtual receipt wherein the block chain ledger is a permanent ledger preventing changes to the virtual receipt accessible by the customer using identifying data to access the block chain ledger wherein the identifying data is composed of data which is extracted from a scan-able code captured by the customer as well as additional identifiers of identifying data generated by the receipt app of the customer which correlate to the identifiers.

16. The system of claim 15, wherein the scan-able code comprises a plurality of different types of scan-able codes which include: a quick response (QR) code, a matrix code, a 2-dimensional code, or a universal product code (UPC) code.

17. The system of claim 15, wherein the additional identifying data is generated independently by the receipt app of the customer and configured to enable access to the virtual receipt of the block chain ledger in accordance with the identifiers generated by the merchant POS.

18. The system of claim 15, further comprising:
notifying by the computing platform, when the virtual receipt is sent to the app cloud storage, the receipt app of the virtual receipt for access and to enable receipt of the virtual receipt by the mobile device of the customer.

19. The system of claim 18, further comprising:
notifying by the computing platform, when the virtual receipt is sent to the app cloud storage, the receipt app of the virtual receipt for access and to enable receipt of the virtual receipt by the mobile device of the customer when a confirmation is received by the customer.

20. The system of claim 18, further comprising:
responding, upon notifying, to a request to access the virtual receipt and subsequent request to receive the virtual receipt by the customer via the receipt app, by sending the virtual receipt via the computing platform to the receipt app of the customer.
